(19) United States
(12) Patent Application Publication
(10) Pub. No.: US 2010/0089804 A1
(43) Pub. Date: Apr. 15, 2010

(54) METHOD FOR IDENTIFYING A SUBSTANCE OR OBJECT USING A PLURALITY OF EXCITATION VECTORS

(76) Inventors: Claude Lambert, Saint Michel Sur Orge (FR); Jean-Michel Hachin, Levallois-Perret (FR)

Correspondence Address: BROWDY AND NEIMARK, P.L.L.C.;624 NINTH STREET, NW, SUITE 300, WASHINGTON, DC, 20001-5303, US

(21) Appl. No.: 12/557,774

(22) Filed: Sep. 11, 2009

Related U.S. Application Data
(63) Continuation-in-part of application No. 10/533,356, filed on Apr. 29, 2005, now Pat. No. 7,605,372.

(30) Foreign Application Priority Data
Oct. 29, 2002 (FR) 0213718

(51) Int. Cl. B07C 5/00; G01J 3/42; G01T 1/20

(52) U.S. Cl. 209/576; 356/319; 250/361 R; 250/362

(57) ABSTRACT

The method concerns the identification and/or authenticating of substances or objects with a view, for example, of carrying out sorting of said substances or objects. Its comprises a step of application to the substance or object of a plurality of excitation vectors, a step of detecting the responses to said excitation vectors, and a step of determining at least one piece of information concerning said substance or object.

It may comprise a preliminary phase comprising the steps of selecting at least one marker reacting to at least one of said excitation vectors, elaborating a correspondence table, and a step of incorporating at least one selected marker within or at the surface of the substance or object.

### CROSS-REFERENCE TO RELATED APPLICATIONS

This application is a Continuation-in-Part of application Ser. No. 10/533,356 filed Apr. 29, 2005, which is National Stage of PCT/FR2003/003233, filed Oct. 29, 2003, which claim priority to French application No. 0213718, filed Oct. 29, 2002. The entire content of all three applications are incorporated herein by reference.

### BACKGROUND OF THE INVENTION

1. Field of the Invention

The present invention concerns a method for authenticating objects or substances using chemical marking or tracing. It applies more particularly but not exclusively to the fight against counterfeiting, to automatic sorting and also to make quality control and to have traceability of materials comprising recycled materials.

2. Description of the Prior Art

As a general rule, numerous objects or substances whether in transit or on sale are identified by means of a bar code. With this code it is possible to define products but it is not sufficient for their authentication i.e. for certifying after analysis that the object or substance is indeed the one defined by the bar code.

In an attempt to solve this problem, methods integrating a chemical marker into objects or substances have been developed. However, it is necessary to have recourse to laboratories to perform analyses and detect counterfeited products: this procedure is far too time-consuming and laborious.

As for the solution which consists of developing analytical equipment specific to each product, this solution is not economically viable.

### OBJECT OF THE INVENTION

The object of the invention is to solve these drawbacks by proposing that only one apparatus is used for a multiplicity of products.

### SUMMARY OF THE INVENTION

For this purpose, it proposes an authentication method for different objects or substances to be identified, comprising at least the two following successive phases:
An initial phase comprising:
   choosing a plurality of chemical markers which, when excited by an incident light ray, emit energy radiations whose frequency spectra can be distinguished from one another and with respect to the objects or substances in which they are intended to be incorporated,
   allocating to and then incorporating in each of the objects or substances a previously chosen combination of markers, the combination being different to those allocated to other objects,
   determining an authentication code using parameters relating to the presence or absence of markers in the allocated combinations,
   storing, in a computer memory system, the authentication code of all the objects or substances, and related data corresponding to these objects or these substances,
   allocating to the object or substance an identification code, such as a bar code or similar, this identification code possibly being associated with the object, with the substance, with its container and/or its packaging,
   storing, in the memory of said system, the identification codes for each of the objects,
   defining a correspondence between the identification codes and authentication codes.
An identification and authentication phase by said system, this phase comprising:
   theoretical identification of the object or substance by reading the identification code associated with the object,
   spectrophotometer analysis of at least part of the object or substance so as to detect said above parameters, in particular the presence or absence of markers, and determination of the authentication code of the object or substance,
   authentication of the object if the theoretical identification code corresponds to the authentication code,
   emission of a validation signal when correspondence is detected or of an alert signal when the authentication code does not correspond to the identification code.

In this method, the spectrophotometric analysis phase may comprise the following steps:
irradiation of the marked object or substance using a light beam with wide frequency spectrum,
sending the waves transmitted or reflected by the object or substance, after emission by a generator, onto a dispersing element which deflects the waves so as to obtain a light spectrum of the light intensity at different zones of the spectrum corresponding to different wavelength ranges, or onto specific or dedicated filters,
detecting the light intensity in each zone,
comparing this intensity with one or more threshold values specifically allocated to this zone and which are stored in memory as being said above parameters,
the result of this comparison contributing towards determining the authentication code of the object.

Advantageously, the determination of the spectrum zones to be analysed, and of the different parameters allocated to each of these zones, may be made by the system using the identification data. This solution provides improved reliability of results and considerably reduces the required power of processing means.

The parameters relating to the presence or absence of markers in the allocated combination and used for determining an identification and/or authentication code particularly comprise:
the presence or absence of fluorescence,
a fluorescence time that is greater or less than at least one threshold value,
the presence or absence of a peak at a predetermined wavelength and optionally the amplitude and/or width of this peak,
emission peak heights corresponding to a concentration of markers that is greater or less than one or more predefined threshold values.

To increase the number of possible combinations, different concentrations of markers may be used to obtain rays of different intensity.

Also, to overcome any optical factors likely to disturb the reading and subsequent spectrophotometric analysis, the invention proposes two measures which may be used separately or in combination.

The first measure consists of servo-controlling the light intensity emitted by the light radiation generator in relation to the difference between the value of the light intensity detected over a predetermined frequency range that is not affected by the presence of the markers, and a predetermined set value.

The second measure consists of incorporating in the object and/or substance one or more calibration markers used by the computer system for correction or calibration purposes so as to overcome noise derived for example from the composition of the substance or object, from variations in positioning such as angle of incidence and distance to the object, or from transparent matter surrounding this substance or object.

These two measures prove to be essential when several intensity levels are used as parameters.

According to one variant, chemical marking may be made via a label, an insert or any other medium containing the marker or markers.

Advantageously, this label may comprise a reflective zone coated with a transparent layer containing markers. With this solution it is possible to conduct reflection spectrophotometry which considerably reduces energy losses.

The authentication data may comprise the combination of chosen markers, the wavelengths of characteristic rays, their intensity, possible fluorescence time . . . .

It is therefore not necessary to cover all wavelengths, it is sufficient to analyse the ranges of values corresponding to the expected rays which are identified using the identification code in order to verify their presence or absence without taking into account the zones located outside these ranges.

To conduct authentication, the operator performing the analysis does not need to know the theoretical identity of the object or substance since it is provided by the bar code directly to the computer system performing data comparison.

Reading of identification code as well as authentication code can be done simultaneously at several levels with the manufacturer signature and an identification of the type or the grade of the material.

Said method may be used in the fight against counterfeiting, but may also be applied to automatic sorting. For example, when recycling plastic, it could be considered to use a combination of markers per type of plastic or per grade of plastic enabling subsequent sorting per type or per grade once authentication has been carried out.

In this method the coding and identifying steps can be coupled to pattern recognition step.

Furthermore, it can be useful to code several types of information concerning a substance or an object, for instance its composition, its recycling process, its maker . . . . There is as well the problem of black or strongly coloured substances or objects which are relatively frequent.

Coloration is due to the presence within the substance of colored pigments, notably carbon black, in variable proportions. Carbon black is used as a protective agent against radiations, mainly UV radiation, in outdoor applications or as a stabilizing and strengthening agent. Its action mainly consists of absorbing the radiations received by the substance which may cause degradations of the polymeric chains. However, it also has the property of absorbing radiations which may be notably emitted in the visible spectrum by the substance making up the object and/or the markers incorporated in the substance, which explains its dark or black color. The result of this is that excitation by a light source does not cause any spectral emission allowing easy extraction of information relating to the substance with very small concentrations of markers if it is strongly colored or black.

It is therefore an aim of the invention to solve these problems thanks to a method for identifying and authenticating substances or objects independently of their colours and with very low concentrations of markers, by proposing a method comprising the following steps:
an excitation step comprising the application to a substance or to an object of a plurality of excitation vectors,
a step for detecting the responses of the substances or objects subject to said excitation vectors,
a step for determining at least one piece of information relating to said substance or to said object on the basis of matching said obtained responses and a pre-established correspondence table.

The method consists of subjecting a substance or an object to a combination of different excitation vectors and not only to a light excitation. The excitation vectors may be applied either simultaneously or sequentially.

Advantageously, the method may be preceded by a phase comprising:
a step for selecting at least one marker reacting to at least one of said excitation vectors by emitting a remotely detectable response, said markers being provided in order to be incorporated within or at the surface of substances without substantially modifying the physical or chemical properties of said substances,
a step for elaborating a correspondence table consisting in a set of one-to-one relationships between a combination of responses and information relating to said substance,
and a marking step in which at least one marker selected within or at the surface of the substance is selectively incorporated, in order to activate said substance or objects consisting of said substance.

In this preliminary phase, at least one marker is selected which may be incorporated into substances, for example plastic materials, at a very low concentration, each marker Sᵢ having a response R_{i,j} to an excitation vector Vⱼ. Each marker does not have to respond to each excitation vector, it is sufficient that it responds to at least one excitation vector.

In the most current case, a marker Sᵢ responds to the excitation vector Vᵢ and there are as many substances as there are excitation vectors. However two markers may respond to the same excitation vector provided that their responses are distinct, for example in fluorescence, at different wavelengths. The number of markers used in a substance may therefore be larger than the number of excitation vectors. Conversely, the number of markers may be less than the number of excitation vectors in the case when one or more markers would respond to different excitation vectors. Multiplication of the excitation vectors has the benefit of allowing resorting to wider families of substances and therefore broadening the coding ability of the method.

The very small concentration used for the markers is essential:
it guarantees that incorporation of the markers will not modify the physical or chemical properties of the substances into which they will be incorporated,
non-toxicity tests can be omitted,
the markers used will be detectable with difficulty and notably invisible to the naked eye,
additional expenditure will be low.
The markers may be of different nature:
chemical compounds,
particles, notably nanoparticles, i.e. particles or structures, the size of which is measured in nanometers.

The markers may be embedded into the bulk or positioned at the surface, for example by impregnation (for example in a textile, a tincture . . . ), by coating (varnish, paint coating, spraying) on various supports, for example aircraft metal parts, whether this be on the whole of the surface or punctually (screen-printing, brush plating) or as marked labels either partly visible or not. Advantageously, this coating may comprise a reflecting area covered with a transparent layer containing markers. With this technique, it is thereby possible to carry out spectrophotometry by reflection which considerably reduces the energy losses.

As the responses of the markers to the different excitation vectors are known, it is possible to elaborate a correspondence table between combinations of markers and therefore responses to excitations and information provided for the substances in which they will be incorporated. For example, if three substances S₁, S₂ and S₃ and two excitation vectors V₁ and V₂ are used and if:
marker S₁ provides a response R_{1,1} to the excitation V₁,
marker S₂ provides a response R_{2,1} to the excitation V₁,
marker S₃ provides a response R_{3,2} to the excitation V₂,
   2³−1=7 combinations of possible responses are obtained, and therefore a correspondence table with 7 inputs.

More generally, the use of n marking substances in a material (n≧1), subject to p excitation vectors (p≧2), in order to obtain r responses (r≧n*p) enables a correspondence table to be constructed with 2^{r}−1 inputs, and therefore to be coded with as many pieces of information relating to the substance.

This may therefore result in a great possibility of coding information relating to a substance or to an object incorporating these substances by multiplying the excitation vectors and the markers.

In the step for determining information relating to said substance or to said object:
said obtained responses are compared to combinations of responses present in said correspondence table,
said information is allocated when said comparison reveals an identity.

The excitations to which the substance is subject cause one or more responses. These responses are matched with the correspondence table between expected responses and information concerning the substance, which for example enables identification of this substance. If no response is obtained, or if the obtained response does not appear in the correspondence table, it will not be possible to allocate information concerning the substance.

In a step for elaborating the correspondence table, it is possible to only take into account the presence or the absence of a marker response to the excitation vectors, and/or the intensity of a marker response, for example as a plurality of response thresholds.

The spontaneous emission of a selected marker in the absence of any excitation vector may also be taken into account, for example in the form of spontaneous emission of electromagnetic radiation or particles, either neutral or charged particles, notably in the case of radioactivity, or of emission of molecules, notably odorous molecules.

Advantageously, in the detection step, it is possible to take into account the emission of the material under the effect of the excitation vectors, notably for correcting the obtained responses, for example for subtracting background noise.

A large number of excitation vectors may be contemplated:
an electromagnetic excitation, notably an optical excitation, for example a light beam with a wide frequency spectrum in the infrared or UV, X rays,
an electrical excitation, for example as the application of an electric field,
a magnetic excitation, for example as the application of a magnetic field,
a thermal excitation,
an excitation by a particle flux, notably of electrons.

Advantageously, the provided responses from the markers and the obtained responses are selected from the list comprising:
electromagnetic emission, notably light emission, fluorescence (visible, X, UV) or phosphorescence,
magnetic field variation,
electric field variation.

As indicated above, these responses are remotely detectable.

Advantageously:
in the marking step, the substances or objects are marked with a marker comprising yttrium vanadate doped with europium, at a concentration of less than 200 ppm, or even less than 100 ppm,
in the excitation step, an electromagnetic excitation in the range comprised between 230 and 390 nm, preferentially 330-340 nm is applied to the substance or the object,
in the detection step, detection of said marker within a band centered on 610-620 nm and measurement of the intensity of the corresponding peak are carried out.

Yttrium vanadate doped with europium, excited between 230 and 390 nm, i.e. in the near UV, used alone or in combination with other markers, provides a response centered on 610-620 nm which may exploited in black or strongly colored substances.

When a black or strongly colored substance is excited in the near UV, a relatively large background noise is observed, which requires signal processing, for example in order to form a baseline, so as to extract and quantify the responses. When yttrium vanadate doped with europium is used in combination with another marker, one of them may be used as a calibration, one then operates differentially.

With the method, it is possible to collect one or more pieces of information relating to a substance or an object, for example a chemical property, notably its chemical composition and therefore identify the material being examined or its quality (type, grade). The information may also relate to the manufacturing of the substance or of the object, for example the identity of its manufacturer, its location or its manufacturing date . . . .

Thus, a transition is performed from simple identification of a material or of an object to its authentication, i.e. the possibility of distinguishing an authentic object from a non-authorized copy, for example within the scope of the struggle against counterfeiting.

By its generality, the method is applicable to any types of substances, notably black or strongly colored substances, which absorb a large range of radiations.

In the case of an excitation by a light beam, the identification data may comprise the combination of selected markers, the wavelength of the characteristic radiation lines, their intensity, the duration of possible fluorescence . . . .

Thus, it is unnecessary to observe all the wavelengths emitted by the substance, it is sufficient to analyze the ranges of values corresponding to the lines provided in the correspondence table, stored in memory beforehand, in order to check their presence or their absence without being concerned with the zones located outside these lines.

The identification code may result from a combination of markers and may consist in a binary number, the binary figures of which each correspond to the presence or the absence of a marker.

In the case of an identification with view to recycling substances, the use of this combination of markers may be contemplated in order to code the type or the grade of substances, for example plastic materials, which enables them to be sorted per type or per grade once identification is achieved. The code may also relate:
to the beneficiation, recycling, rejection or elimination route, this route may be common for substances of different compositions and may change over time,
to the fact of being aware that the substance has a particular property, for example if it is a secondary i.e. already recycled raw material.

By extension, by combining several excitation vectors and markers it is possible to obtain several pieces of information of different nature on a material, for example the authentication of one or more actors during the life cycle of a substance or of an object (manufacturer, distributor, owner . . . ); for this purpose, it is sufficient that the substance incorporated into the object has been marked beforehand depending on one or more actors involved in the life cycle of a substance or of an object and not only on its composition.
The method is therefore applicable:
   to the sorting of substances or objects,
   to the recycling of substances or objects,
   to the traceability of substances or objects,
   to quality control, for example checking whether a batch of already sorted substances actually corresponds to the announced composition, in order to optimize the recycling operations.

The method is applied to the identification of any type of substance, notably substances with any more or less dark coloration; it is particularly applicable to the identification of colored or black substances.

### BRIEF DESCRIPTION OF THE DRAWINGS

Embodiments for implementing the invention are described below as non-limitative examples.

FIG. 1 is a diagram showing a device using the method of the invention, the waves being transmitted;

FIG. 2 is a functional diagram of the method of the invention;

FIG. 3 is a diagram showing a device using the method of the invention, the waves being reflected;

FIG. 4 is a diagram showing a device using the method of the invention, the waves being reflected onto a label.

FIG. 5 illustrates natural fluorescence curves of three plastic compounds;

FIG. 6 illustrates fluorescence curves of black polypropylene, with different marker concentrations.

### DESCRIPTION OF THE PREFERRED EMBODIMENTS

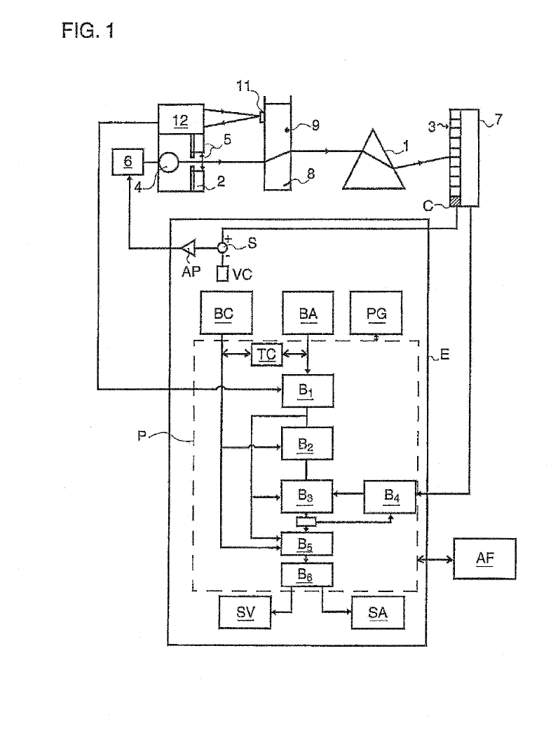

In the example in FIG. 1, it is the waves which are transmitted through a substance containing a combination of markers and more precisely onto a sample possibly diluted in a solution which are analysed.

It is to be noted that this type of analysis can also be made on objects whose substance so permits, or directly on the substance through its recipient.

In this example the identification and authentication device using the method of the invention comprises a spectrophotometer comprising:
a generator of light radiation with long frequency spectrum and adjustable intensity using a light source 4 supplied by a power-adjustable electric current generator 6; a collimator 2 in whose axis a lens 5 is positioned,
a product sample 8 contained in a transparent recipient 9 positioned in the optical axis of the light generator,
a dispersing element 1 positioned in said axis on the side of the recipient 9 located opposite the light generator; this dispersing element 1 (prism or diffraction network) decomposes the light ray in relation to frequency, producing a spectrum,
spectrum detection means, here a charge transfer detector array 3 to detect the radiations emitted at different spectral levels by the dispersing element 1 and to transmit a digital signal representing the detected spectrum to an electronic system.

As mentioned previously, the light source 4 is a source with wide frequency spectrum. It may consist of arc lamps (Xenon type) or of a light bulb generating a white light. Optionally, it may consist of a plurality of laser radiation sources specifically chosen in relation to the type of the chemical markers used, a mixer then being used to mix the different radiations emitted by these sources.

The lens 5 may for example consist of an achromatic doublet.

Evidently, the electric current generator 6 may also be used to supply the electronic circuits associated with the spectrophotometer.

In this example, the detector array 3 comprises a cell C located at a position of the spectrum that is not affected by the presence of chemical markers.

This cell C emits a detection signal applied (after amplification) to the input of a subtractor S whose second input receives a calibrated voltage VC. The output of this subtractor S is applied to a power amplifier AP which pilots the generator 6 so that the output of the subtractor S is maintained at a constant value, preferably equal to zero.

With this arrangement, it is ensured that the level of light intensity received by cell C is constant. This overcomes disturbances which may cause variations in the light intensity of the radiation transmitted through sample 8.

According to the invention, the light source is associated with a bar code reader 12 which emits light radiation (laser for example) in the direction of a bar code 11 carried by recipient 9. This reader 12 comprises a receiver enabling detection of the radiation reflected by the bar code. An electronic circuit processes the data received by this receiver and generates a digital signal representing this bar code to be sent to the electronic system E.

The electronic system comprises a processor P (indicated by the dashed line) associated with means for memorising a database of identification codes BC, a database of authentication codes BA and a management program for the various processing operations PG, and with display and signalling means AF.

This processor P is designed so as to conduct theoretical identification (block B1) of recipient 9 using the signal delivered by the bar code reader 12, from the database of identification codes BC. Once theoretical identification has been made, processor P determines the spectrum zones to be investigated (block B2). For this purpose, in addition to the readout identification code, it uses the corresponding authentication code by means of a correspondence table TC between the two databases BC, BA. The processor P then analyses (block B3) the spectrum zones previously determined through the signal provided by the detector array 3.

If a calibration marker is used, this signal may be corrected (block B4) before analysis using the digital signal produced by the detector corresponding to this calibration marker.

The processor P then determines (block B5) the detected authentication code which it compares (block B6) with the predetermined identification code. If there is agreement between these two codes, the processor emits a validation signal SV. If not, the processor emits an alarm signal SA.

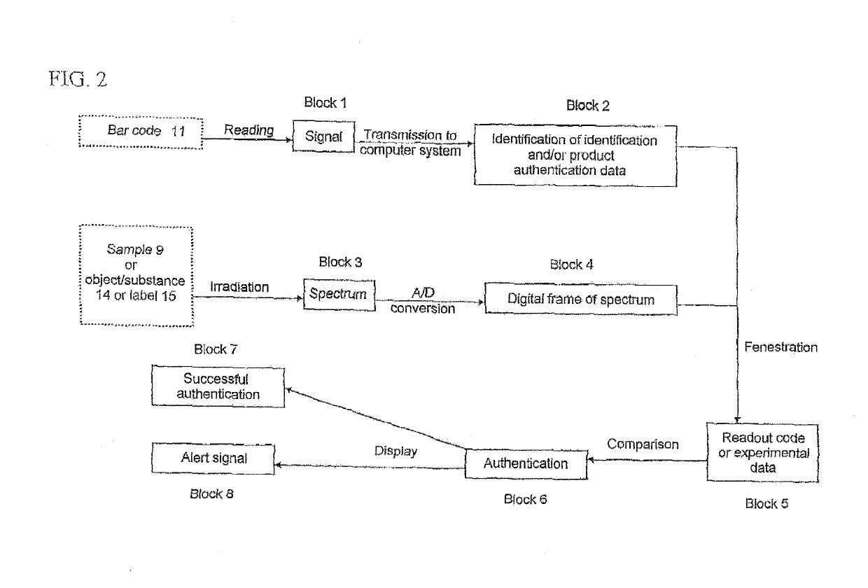

The method of the invention used by the device illustrated FIG. 1 comprises the following phases (FIG. 2):
An initial phase comprising:
   choosing markers in relation to their respective suitability and with respect to the substance,
   adding these markers at different concentrations to said substance,
   determining the authentication codes formed of binary figures representing the presence or absence, even the concentration of the markers, these codes being stored in memory in the electronic system E,
   allocating, to each of these codes, a substance identified by a bar code 11.
An identification and/or authentication phase comprising:
   reading the bar code 11, located on the recipient of the marked substance by means of the bar code reader 12 and emitting a specific signal containing an identification code of said substance (block 1),
   transmitting said signal to the electronic system E which identifies this identification code (block 2),
   spectrophotometric analysis comprising:
      irradiation of the substance using the ray source 4,
      transmission of the transmitted waves onto the dispersing element 1 which deflects them differently in relation to their wavelength,
      obtaining a spectrum of transmitted radiation by means of the planar waves so deflected, which, in a detection zone consisting of the series of charge transfer detection arrays 3, give a succession of images of the source (block 3),
      sampling this spectrum then converting the analogue signal into a digital signal having a predetermined digital frame (block 4),
      windowing in relation to the wavelength ranges indicated in the authentication data stored in memory and extracted through identification of the bar code, so as only to give consideration to the presence of absence or rays characteristic of the markers, which then determines a readout code (block 5),
      comparison of the data or authentication code with the experimental data or readout code so as to conduct authentication of the substance (block 6),
   visual display of the result, for example on a screen 13 and/or audibly:
      successful authentication if the authentication codes and readout code tally (block 7),
      alert signal in the event of non-authentication if there is disagreement between the authentication codes and the readout code (block 8).

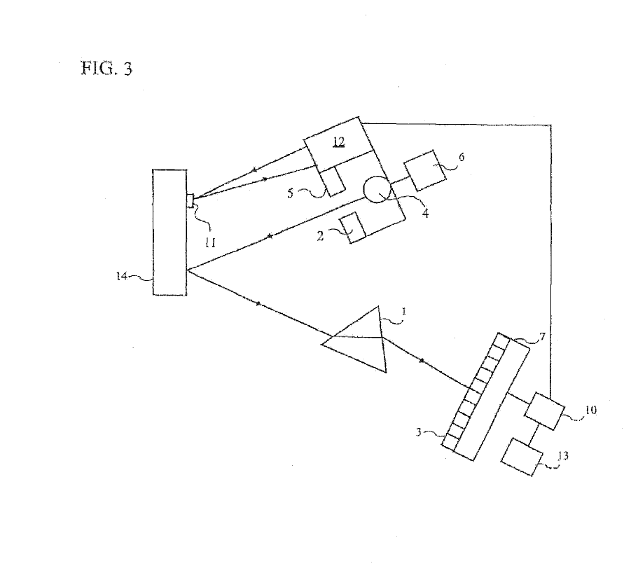

FIG. 3 illustrates an analysis using waves reflected on at least part of an object or substance 14.

In this case, the dispersing element 1 is located on the axis of the reflected wave.

The method is the same as described above for the example in FIG. 1.

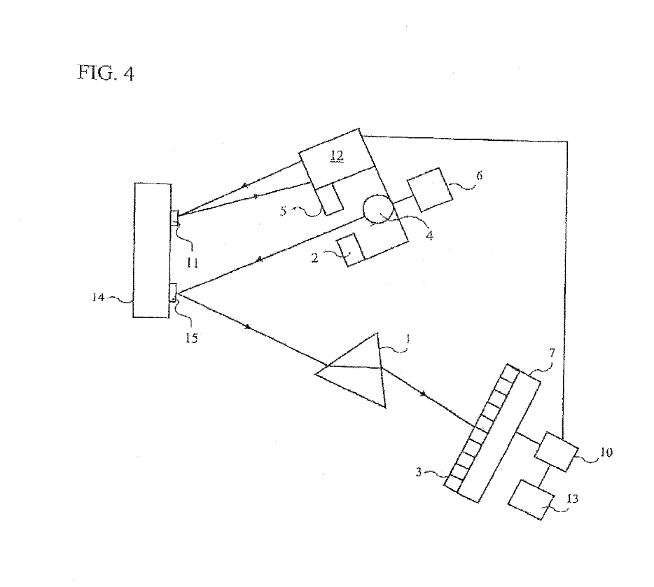

FIG. 4 illustrates a variant of the example in FIG. 3. Here the markers are not directly integrated in the object or substance 14 but are applied by means of a film, a transparent varnish on a label 15 which is affixed to the object to be marked.

The method is the same as described above for the example in FIG. 1. For a better analysis result, the label may be reflective.

In addition, the use of a label free of any marker and optionally coated with a film or varnish used for applying markers may, when processing data, enable the elimination of corresponding signals and simplify analysis. The marked label then the blank label are irradiated after which, during data processing, the spectrum data of the blank label are subtracted from the spectrum data for the marked label.

When fluorescent markers are used, it can be considered to conduct a second measurement after a time δt to verify fluorescence time.

The tracers used may be organic or inorganic. They may contain rare earths such as dysprosium, europium, samarium, yttrium . . . .

Some markers used and their characteristics are given as examples in the table below.

They are commercially available from companies such as BASF, Bayer, Glowburg, Lambert Rivière, Phosphor Technology, Rhodia, SCPI, . . . .

| | | Wavelength of emission |
|---|---|---|
| | Excitation wavelength | peak |
| Marker | λₑₓ + Δλ_{1/2} | λₑₘₐₓ + Δλ_{1/2} (nm) |
| A | 300 ± 40 | 480 ± 6 |
| | | 572 ± 6 |
| B | 300 ± 40 | 562 ± 10 |
| | | 601 ± 6 |
| C | 335 ± 35 | 470 ± 85 |
| D | 365 ± 70 | 480 ± 90 |
| E | 350 ± 20 | 612 ± 3 |
| F | 380 ± 45 | 480 ± 75 |
| G | 365 | 610 ± 50 |

It is to be noted that the markers are not limited to commercially available markers, they may be synthesized by total synthesis or derived from commercial markers.

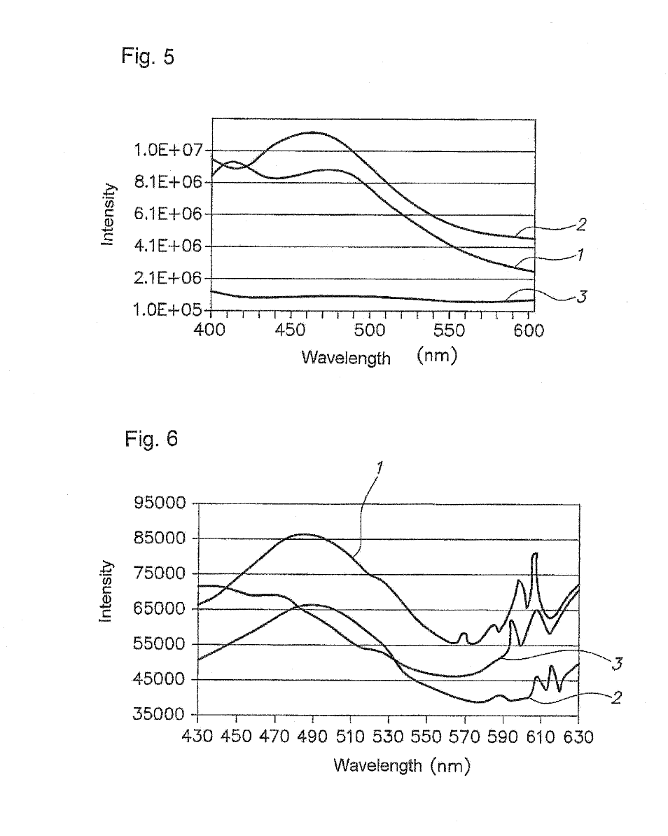

FIG. 5 illustrates the fluorescence intensity curves of three non-marked plastic compounds, acrylonitrile-butadiene-styrene (ABS, curve 1), polypropylene (PP, curve 2) and black-pigmented polypropylene (curve 3), ABS and PP being two substances currently used. The illumination is produced by means of a UV-TOP light-emitting diode (LED) operating at about 330 nm, i.e. in the near UV, with a rated output power of 1 mW and the spectra are obtained with a fluorescent spectrometer FluoroMax®.

It is seen:
that the natural fluorescent intensity of ABS and of PP decreases in the region of the red and near infrared (λ>500 nm),
that the fluorescence intensity of black-pigmented PP is constant in the whole visible and near IR domain, but with a lower intensity by more than two orders of magnitude than that of non-pigmented samples.

Taking into account the lower intrinsic response of these substances in the red and near IR domain on the one hand and the uniformly low response of the black-pigmented substance, it is inferred therefrom that it may be advantageous to use markers which, after irradiation of the marked object or substance, emit radiations in a frequency band corresponding to red—near infrared.

Advantageously, markers will be selected which have a response in the range from 500 to 650 nm.

Taking into account the Stokes shift, the irradiation should take place in a range of smaller wavelengths, for example in the near UV, in the 220-380 nm range.

The markers used may be chemical, organic or mineral, or consist of nanoparticles. These may be products made on demand or commercial products.

For example, markers marketed by “Phosphor Technology Dyes” (registered trade name) may be used, the characteristics of which are the following:
marker H: two emission peaks at 614 and 618 nm,
marker I: an emission peak at 515 nm.

These markers further have the advantage of exhibiting good thermal and chemical stability, as well as good UV-fastness.

In order to obtain signals with which the substance will be identified:
a high power excitation source will be used, typically a Xenon arc lamp, a UV LED or a laser;
it will be proceeded with amplification of the signal corresponding to said transmitted or reflected light intensities;
signal processing corresponding to said emitted radiations will be carried out in order to reduce the background noise, in particular by exploiting the level of the characteristic peaks of the marker(s).

FIG. 6 illustrates the results obtained on the Xenon arc lamp and a fluorescence spectrometer FluoroMax®, in the case of black polypropylene marked with the marker H, at two different concentrations, 200 ppm (curve 1) and 100 ppm (curves 2 and 3). It is seen that the two characteristic peaks of the marker H clearly emerge from the background noise at 614 and 618 nm, thereby allowing its identification and thereby actual identification of the substance in which it is comprised, even when it is black.

1. A method for identifying and/or authenticating a substance or an object, notably with view to carrying out sorting of substances or objects, comprising:
an excitation step comprising the application to a substance or to an object of a plurality of excitation vectors,
a step for detecting responses of the substances or objects subject to said excitation vector,
a step for determining at least one piece of information concerning said substance or said object on the basis of said obtained responses and of a pre-established correspondence table.

2. The method according to claim 1,
comprising:
a preliminary phase comprising:
a step for selecting at least one marker reacting to at least one of said excitation vectors by emitting a remotely detectable response, said at least one marker being provided in order to be incorporated within or at the surface of substances without substantially modifying the physical or chemical properties of said substances,
a step for elaborating a correspondence table consisting in a set of one-to-one relationships between a combination of responses and a piece of information concerning said substance,
a marking step into which at least one selected marker is selectively incorporated within or at the surface of a substance, so as to activate said substance or objects consisting of said substance.

3. The method according to claim 2,
wherein in the step for determining a piece of information concerning said substance or said object:
said obtained responses are compared with the combinations of responses present in said correspondence table,
said information is allocated when said comparison reveals identity.

4. The method according to claim 2,
wherein in the step for elaborating a correspondence table, the presence or the absence of a marker response to said excitation vectors is only taken into account.

5. The method according to claim 2,
wherein in that, in the step for elaborating a correspondence table, the intensity of a marker response to said excitation vectors is taken into account.

6. The method according to claim 2,
wherein in the step for elaborating a correspondence table, the spontaneous emission of a selected marker is taken into account.

7. The method according to claim 2,
wherein in the step for detecting the responses, the response of the substance under the effect of said excitation vectors is taken into account, notably for correcting the obtained responses.

8. The method according to claim 1,
wherein the excitation vectors are selected from the list comprising:
an electromagnetic excitation, notably an optical excitation,
an electrical excitation,
a magnetic excitation,
a thermal excitation,
an excitation by a flow of particles, notably electrons.

9. The method according claim 1,
wherein the remotely detectable responses are selected from the list comprising:
an electromagnetic emission, notably an optical emission,
a magnetic field variation,
an electric field variation.

10. The method according to claim 2,
wherein:
in the marking step, the substances or objects are marked with a marker comprising yttrium vanadate doped with europium, at a concentration of less than 200 ppm,
in the excitation step, an electromagnetic excitation in the range comprised between 230 and 390 nm is applied to the substance or the object,
in the detection step, detection of said marker in a band centered on 610-620 nm and measurement of the intensity of the corresponding peak are carried out.

11. The method according to claim 10,
wherein the substances or objects are marked with a marker comprising yttrium vanadate doped with europium, at a concentration of less than 100 ppm.

12. The method according to claim 6,
wherein the spontaneous emission is selected from the list comprising:
an emission of electromagnetic radiation,
an emission of either neutral or charged particles,
an emission of molecules.

13. The method according to claim 1,
wherein the information concerning said substance is a chemical property, notably its chemical composition.

14. The method according to claim 1,
wherein the information concerning said substance concerns its manufacturing.

15. The method according to claim 1,
wherein said substance is black or strongly colored.

16. The method according to claim 2,
wherein the marker incorporated during the marking step is a chemical marker which, after irradiation of the marked object or substance, emits radiations in a band of frequencies corresponding to red-near infrared.

17. The method according to claim 16,
wherein said marker emits radiations in the range from 500 to 650 nm.

18. The method according to claim 16,
wherein the irradiation of the object or of the marked substance is carried out in the range from 220 to 380 nm.

19. The method according to claim 19,
wherein the step of detection said electromagnetic emission comprises a spectrophotometric analysis.

20. The method according to claim 19,
wherein said spectrophotometric analysis further comprises the following steps:
amplifying the signal corresponding to said transmitted or reflected electromagnetic emission,
processing said signal with view to reducing the background noise.

21. The method according to claim 1,
further comprising, prior to the excitation step, a step for milling the objects as particles, and in that it applies to said particles.

22. An application of the method according to claim 1, to the sorting of substances or objects.

23. An application of the method according to claim 1, to the recycling of substances or objects.

24. An application of the method according to claim 1, to the authentication of at least one actor in the live cycle of a substance or of an object.

25. An application of the method according to claim 1, to the traceability of substances or objects.

26. An application of the method according to claim 1, to the quality control of substances or objects.
